(19) United States
(12) Patent Application Publication
(10) Pub. No.: US 2023/0347392 A1
(43) Pub. Date: Nov. 2, 2023

(54) IMPROVEMENTS IN THE CLEANING OF LIQUID SPRAY APPARATUS

(71) Applicant: PPG Europe B.V., Uithoorn (NL)

(72) Inventors: Anthonius Hendrikus Wilhelmus Van Den Berg, Oegstgeest (NL); Cornelis Fredericus Willijbrordes Brandjes, Akersloot (NL); Johannes Gerardus Josef Weijnen, Alphen aan den Rijn (NL)

(73) Assignee: PPG Europe B.V., Uithoorn (NL)

(21) Appl. No.: 18/002,287

(22) PCT Filed: Jun. 24, 2021
(86) PCT No.: PCT/EP2021/067417

§ 371 Date: Dec. 19, 2022

(30) Foreign Application Priority Data
Jun. 26, 2020 (EP) 20182644.3

(51) Int. Cl. B08B 9/032; C11D 11/00; C11D 3/22; C11D 3/20; C11D 3/43; C11D 3/00; C11D 1/62

(52) U.S. Cl. CPC B08B 9/0321; C11D 11/0041; C11D 3/225; C11D 3/2068; C11D 3/43; C11D 3/0026; C11D 1/62; B08B 2209/032; B05D 1/02

(57) ABSTRACT

A method of cleaning a coating liquid spray apparatus after use, the method comprising passing a water-based cleaning liquid through the coating liquid spray apparatus; wherein the cleaning liquid contains a thickener.

### FIELD

The invention relates in general to the field of liquid spray apparatus intended to deliver a water-based coating liquid (for example a latex paint) onto a surface with the aim of providing a dried coating on the surface after a drying period. The invention relates in particular to the cleaning of the liquid spray apparatus to put it into a good condition for subsequent spray coating operations.

### BACKGROUND

As noted above the invention relates to the application of a coating liquid by spraying. The coating liquid may be a pigmented or non-pigmented coating liquid, and may include paint, lacquer, varnish and any other coating which may form a film by spraying followed by drying.

Conventionally, a surface is coated by hand using an applicator, for example a brush, pad or roller. Although coating by brush, in particular, can be accurate, the application of the coating liquid onto a surface in this manner is slow. The use of a pad or roller helps to speed up the coating process, albeit at the cost of some accuracy. Nevertheless, all of the aforementioned approaches require the coating liquid to be frequently absorbed onto the specific conventional applicator before the coating liquid can be transferred to the surface.

Another conventional approach is to spray the coating liquid onto the target surface. Spraying is more efficient than direct contact of a brush, pad or roller to the surface because the sprayed coating liquid is typically applied in a continuous or semi-continuous manner from a reservoir. Furthermore, the coverage of the coating liquid onto a surface is generally more consistent than is achieved by a brush, pad or roller application.

A spray apparatus typically comprises a source of coating liquid, a spray applicator and, between them, a transmission line (for example a flexible hose) for the coating liquid. The spray applicator comprises one or more conduits which lead from the input from the transmission line to the spray outlet. The spray outlet may be in form of one or more nozzles. It will be appreciated that the spray apparatus has narrow and inaccessible internal spaces, in which coating liquid may accumulate.

Cleaning of a spray apparatus is needed at the end of a working shift, or when it is intended to change to a different coating liquid, for example to a coating liquid of different colour. A spray apparatus may be flushed with water. However a large volume of water may be needed. Another approach is to use an organic cleaning solvent. Examples of organic cleaning solvents which could be employed include glycols, glycol ethers, esters, ketones and aromatic solvents.

It is an object of embodiments of the present invention to provide a method of cleaning a liquid spray apparatus offering advantage over known methods.

### SUMMARY

According to the present invention there is provided a method of cleaning a liquid spray apparatus for a coating liquid after use, the method comprising passing a water-based cleaning liquid through the liquid spray apparatus; wherein the cleaning liquid contains a thickener.

The dynamic viscosity of the water-based cleaning liquid may exceed the dynamic viscosity of water at ambient temperature. For the purposes of this specification ambient temperature is 23° C.

In accordance with the present invention we have found that the use of the water-based cleaning liquid containing a thickener can give efficient cleaning performance.

The liquid spray apparatus may comprise a source of a coating liquid, a spray applicator and, between them, a transmission line, and means for driving the coating liquid from the source to the spray applicator. The cleaning liquid may be driven through the liquid spray apparatus instead of the coating liquid, when cleaning is required.

Passing of the water-based cleaning liquid through the liquid spray apparatus may entail passing the cleaning liquid through a transmission line leading from a source of the cleaning liquid to the spray applicator, and then through the spray applicator itself. In the method the source of coating liquid may be disconnected, and closed for later use, or removed for disposal. A source of the cleaning liquid may be provided in its place and the cleaning liquid may be impelled through the transmission line and spray applicator. This may be done using the same means for driving that impelled the coating liquid. The spray applicator may be operated to expel the cleaning liquid, in the same way that it was previously operated to expel the coating liquid.

We have found in experiments that the volume of cleaning liquid needed to achieve good cleaning can be significantly less than the volume of a corresponding cleaning liquid which does not contain a thickener.

### DESCRIPTION OF FEATURES OF THE METHOD OF CLEANING

The dynamic viscosity of the cleaning liquid may be at least 1 dPa·s, for example at least 2 dPa·s, for example at least 3 dPa·s. The dynamic viscosity of the cleaning liquid may be at least 4 dPa·s, for example at least 5 dPa·s, for example at least 6 dPa·s, for example at least 8 dPa·s.

The dynamic viscosity of the cleaning liquid may be up to 50 dPa·s, for example up to 30 dPa·s, for example up to 25 dPa·s. The invention the dynamic viscosity of the cleaning liquid may be up to 20 dPa·s, for example up to 16 dPa·s, for example up to 12 dPa·s, for example up to 10 dPa·s.

Definitions of dynamic viscosity given in this specification are as measured on a Physica Rheolab MC1 viscometer using a E100 spindle at a rotation speed of 181 rpm at 23° C.

The thickener may be a non-associative thickener and/or an associative thickener.

A thickener for use in the present invention may comprise a non-associative thickener.

A non-associative thickener may be the only class of thickener used in the present invention.

Non-associative thickeners are water-soluble or water-swellable polymers which increase viscosity mainly by overlap and/or entanglement of their polymer chains and/or by their occupation of large volumes of space within the cleaning liquid. Non-associative thickeners may act by thickening an aqueous phase without associating with other components of the cleaning liquid. Water molecules adhere to the polymers by hydrogen bonding leading to an increase hydrodynamic volume and reduced mobility of the water. These effects are promoted by the molecular weight, stiffness and straightness of their polymer chains. Associative thickeners are also water-soluble or water-swellable polymers. They have chemically attached hydrophobic groups that are capable of self-association into micellar-like assemblies as well as being capable of non-specific adsorption onto all colloidal surfaces present. This behaviour results in a transient network of polymer chains which increase the viscosity of liquids.

A non-associative thickener for use in this invention may be of any available type. An example is a cellulosic thickener, an acrylic thickener, a starch based thickener, a gum, a clay, a modified ethylene vinyl acetate compound, and a zirconium, acetate lactate oxo ammonium complex.

Examples of suitable non-associative acrylic thickeners are ACRYSOL ASE-60 (commercially available from DOW), RHEOVIS AS 1130 (commercially available from BASF), VISCOATEX 46 (commercially available from Arkema), and RHEOLATE 125 (commercially available from Elementis).

An example of a non-associative starch-based thickener is EMCOL KP 45 K (commercially available from Emsland Group).

A clay may include a naturally occurring clay, synthetic clay, and organically modified clay. Suitable classes of clay include smectites, bentonites and hectorites. Suitable examples include BENTONE EW, a naturally-occurring hectorite clay available from Elementis; and synthetic smectite clays sold under the trade name LAPONITE, available from Byk.

An organically modified clay (organoclay) which can be used as a non-associative thickener may be an organically modified phyllosilicate, derived from naturally occurring clay mineral or by synthesis. Typically the organic modification is by exchanging the original interlayer cations for organocations (typically quaternary alkylammonium ions), thereby generating an organophilic surface consisting of electrostatically linked organic moieties. The lamellar structure remains analogous to the parent phyllosilicate. Examples include organically modified hectorite clay, organically modified bentonite clay, and organically modified smectite clay. Specific examples of organically modified clays are BENTONE LT (commercially available from Elementis) and OPTIGEL WM LT (commercially available from Byk).

Examples of suitable gums as non-associative thickeners are OPTIXAN (commercially available from Archer Daniels Midland Co), KELZAN S (commercially available from CP Kelco), BETOLIN V 30 (commercially available from Wöllner GmbH), and AGOCEL V 600 30 (commercially available from CHT/Bezema group) and Guar gum, for example FINEPAINT 106 MD (from Finechem SA).

A cellulosic compound which can be used as a non-associative thickener in the present invention may be a cellulose ether, for example an alkyl cellulose (e.g. C₁₋₄ alkyl cellulose), a carboxymethyl cellulose (e.g. sodium carboxymethyl 2-hydroxy C₁₋₄ alkyl cellulose), a hydroxyalkyl cellulose (e.g. hydroxy C₁₋₄ alkyl cellulose), an alkyl hydroxyalkyl cellulose (e.g. a C₁₋₄ alkyl hydroxy C₁₋₄ alkyl cellulose) and a carboxy cellulose. Examples of suitable cellulose ethers are hydroxyethyl cellulose, hydroxylpropyl cellulose, methyl hydroxypropyl cellulose, sodium carboxymethyl 2-hydroxyethylcellulose, ethyl hydroxyethyl cellulose, methyl hydroxyethyl cellulose, methylcellulose and ethylcellulose.

The cellulosic compound which can be used in the present invention may comprise an alkyl hydroxyalkyl cellulose (e.g. a C₁₋₄ alkyl hydroxy C₁₋₄ alkyl cellulose), such as methyl hydroxyethyl cellulose and ethyl hydroxyethyl cellulose (commercially available as TYLOSE MH6000 YP4 from SE Tylose and from other suppliers).

The thickener may be, or may include, an associative thickener.

Associative thickeners are organic or organically modified polymers typically characterised by a hydrophobe—hydrophile— hydrophobe structure. The fact that each associative thickener molecule contains at least two hydrophobic groups (separated by hydrophilic segment(s)), promotes the formation of a three-dimensional network within the liquid, which in turn increases the viscosity.

Classes of associative polymer which could be used in embodiments of the present invention include:
HASE thickeners—Hydrophobically modified Alkali Swellable Emulsions. These are hydrophobically modified acrylic thickeners.
HEUR thickeners—Hydrophobically modified Ethylene oxide Urethane Rheology modifiers. HEUR molecules typically comprise hydrophilic blocks and hydrophobic blocks terminating in hydrophobic groups. Suitable HEUR thickeners include urethane polymers having at least three low molecular weight hydrophobic groups at least two of which are terminal (external) hydrophobic groups.
HEURASE thickeners. This is a class of hydrophobically modified ethoxylated oxide urethane alkali-swellable emulsion products.
HEAT thickeners—Hydrophobically modified Ethoxylated Aminoplast Thickeners.
HMPE thickeners—Hydrophobically Modified Polyether.
HMHEC thickeners—Hydrophobically Modified Hydroxy Ethyl Cellulose.
SMAT thickeners—styrene-maleic anhydride terpolymers.
hydrophobically modified polyacrylamides in which hydrophobic groups are incorporated as free radical copolymers with N-alkyl acrylamides.
nonionic acrylamide co-polymers are, as described in U.S. Pat. No. 4,395,524, at column 3.

The amount of thickener may be selected by the skilled person to impart a desired dynamic viscosity value to the cleaning liquid and so is dependent on the chemistry of the thickener, and its thickening power. However by way of guidance it is considered that the amount of thickener present to achieve a useful effect may be at least 0.1% wt/wt, for example at least 0.3% wt/wt. The cleaning liquid may contain at least 0.6% wt/wt of thickener, for example at least 1% wt/wt, for example at least 1.2% wt/wt of a thickener. The cleaning liquid may contain at least 1.4% wt/wt of a thickener, for example at least 1.5% wt/wt.

The cleaning liquid may contain up to 5% wt/wt of thickener, for example up to 3% wt/wt, for example up to 2.5% wt/wt, for example up to 2% wt/wt. The cleaning liquid may contain up to 1.8% wt/wt of a thickener, for example up to 1.6% wt/wt.

These definitions of the amount of thickener refer to the quantity of active thickener agent present.

These definitions of suitable amounts of thickener may be applicable to any thickener but may apply in particular with non-associative thickener, such as of the cellulose ether class which is defined herein; such as to alkyl hydroxyalkyl cellulose (e.g. a C₁₋₄ alkyl hydroxy C₁₋₄ alkyl cellulose), for example methyl hydroxyethyl cellulose and ethyl hydroxyethyl cellulose.

The cleaning liquid may also contain a preservative to protect it from microbial contamination. Suitable preservatives include, but are not limited to, quaternary ammonium chlorides such as didecyldimethylammonium chloride; iodine containing compounds, such as 3-iodo-2-propynyl butyl carbamate (IPBC); hydantoins, such as dimethyloldimethyl hydantoin; isothiazolinones, such as 1,2-benzisothiazol-3(2H)-one, 2-methyl-2H-isothiazol-3-one, 5-chloro-2-methyl-2H-isothiazol-3-one, a mixture of 5-chloro-2-methyl-2H-isothiazol-3-one and 2-methyl-2H-isothiazol-3-one, 2-methyl-1,2-benzothiazol-3(2H)-one, 2-butyl-benzo[d]isothiazol-3-one, and 2-octyl-2H-isothiazol-3-one; pyrithiones, such as zinc pyrithione and sodium pyrithione; parabens, such as methylparaben, ethylparaben, and propylparaben; phenoxyethanol; benzyl alcohol; 2-phenylphenol and salts thereof; bronopol; sorbic acid and salts thereof; 2,2′-dithiobis(N-methylbenzamide); tetrahydro-1,3,4,6-tetrakis(hydroxymethyl)imidazo[4,5-d]imidazole-2,5 (1H,3H)-dione; N-(trichloromethylthio)phthalimide; silver chloride; silver nitrate; and any combination of any of the foregoing.

The total amount of preservative, when present, may be in the range 0.001-2% wt/wt, especially 0.005-1% wt/wt, for example 0.01-0.5% wt/wt although in some compositions of this invention no preservative is present. These definitions of the amount of preservative refer to the quantity of active preservative agent present.

The cleaning liquid may also contain a foam control agent. Many suitable foam control agents are available including polyols, fatty acid esters and siloxane-based products. Many foam control agents are known in the art and for example are described in Additives Guide, Paint & Coatings Magazine, June 2014 and Bieleman, J., et al Additives for Coatings; Wiley-WHC Verlag; Weinheim, 2000, hereby incorporated by reference. Non-limiting suitable foam control agents are available under the brand names of AGITAN, FOAM BAN and FOAMTROL (Münzing Chemie), FOAMASTER and FOAMSTAR (BASF), TEGO FOAMEX (Evonik), BYK (BYK Additives & Instruments), DISPELAIR (Blackburn Chemicals), ADDITOL (Allnex), DREWPLUS and DREW (Ashland). The foam control agent may comprise DREW 210-694 available from Ashland.

The total amount of foam control agent, when present, may be in the range 0.01-1% wt/wt, for example 0.02-0.5% wt/wt, for example 0.05-0.3% wt/wt; although in some compositions of this invention no foam control agent is present. These definitions of the amount of foam control agent refer to the quantity of active foam control agent present.

The pH of the cleaning liquid may be in the range from 3 to 11. The cleaning liquid may be controlled, to be in the range from 3 to 11. The cleaning liquid may contain a pH control agent in an amount to give the desired pH. For example this may be a compound or compounds supplying alkalinity. A buffering system may be included.

Suitable pH control agents for use in the compositions of this invention include, without limitation, alkali hydroxides, for example metal hydroxides, for example sodium hydroxide, ammonia, 2-aminoethanol (MEA), diethanolamine (DEA), isopropylamine, cyclohexylamine, morpholine, diamines, such as N,N-dimethylaminopropylamine (DMAPA), ethylene diamine, methoxy proplyamine (MOPA), 2-(dimethylamino)ethanol (DMAE), 2-(diethylamino)ethanol (DEAE), N-methyldiethanolamine (MDEA), 2-amino-2-methyl-1,3-propanediol (AMPD), 2-amino-2-ethyl-1,3-propanediol (AEPD), 2-(2-aminoethylamino)ethanol (AEEA), N-butylethanolamine, N-butyldiethanolamine, 2-dimethylamino-2-methylpropanol (DMAMP-80), aminoethylpiperazine, di-isopropanol amine, tris(hydroxymethyl)aminomethane (THAM), triethanolamine (trolamine), 2-amino-2-methyl-1-propanol (ANGUS AMP-95), mono alkylamines (methyl, ethyl, isopropyl), dialkyl amines (methyl, ethyl, isopropyl), trialkyl amines (methyl, ethyl, isopropyl), N,N-bis(2-hydroxyethyl)ethylenediamine (THEED), or the like or mixtures or combinations thereof.

The cleaning liquid may contain a surfactant. Due to their amphiphilic nature, surfactants disperse particles, for example pigment particles, in the coating liquid so they may be easily removed. Surface-active agents can be selected from the following groups in the case of this invention: non-ionic, anionic, cationic, zwitterionic and amphoteric surfactants and mixtures thereof. Examples of suitable non-ionic surfactants useful in the present invention include but are not limited to fatty alcohol ethoxylates of the formula CH₃—(CH₂)ₘ—CH₂—(O—CH₂—CH₂)ₙ—OH in which m represents average values from 6.0 to 20.0, and n represents average values from 3.0 to 50.0. Anionic surfactants may include C₈-C₂₂ alkyl benzene sulfonates, C₈-C₂₂ alkyl sulfates, C₈-C₂₂ alkyl ether sulfates with 1 to 25 moles of alkylene oxide, C₅-C₁₀ dialkyl sulfosuccinanates and combinations thereof.

The total amount of surfactant, when present, may be in the range 0.05-5% wt/wt, for example 0.1-2% wt/wt, for example 0.2-1% wt/wt; although in some compositions of this invention no surfactant is present. These definitions of the amount of surfactant refer to the quantity of active surfactant present.

A suitable chelating agent for use herein may be any of those known to those skilled in the art such as ethylenediamine N,N′-disuccinic acids (EDDS), ethylenediaminetetraacetic acid (EDTA), 1,3-diaminopropane-N,N,N′,N′-tetraacetic acid, nitrilotriacetic acid (NTA), ethylidenediamine tris(methylene) phosphonic acid (EDTMP) and salts thereof, and pyrophosphates such as tetrasodium diphosphate, tetrapotassium diphosphate, and sodium polyphosphate. The chelating agent may comprise mixtures of any of the foregoing chelating agents.

The total amount of chelating agent, when present, may be in the range 0.05-5% wt/wt, for example 0.1-2% wt/wt, for example 0.2-1% wt/wt, although in some compositions of this invention no chelating agent is present. These definitions of the amount of chelating agent refer to the quantity of active chelating agent present.

The cleaning liquid may contain a water miscible organic solvent. For example, suitable solvents include alcohols, ketones, glycols and glycol ethers. Lower alkyl alcohols such as methanol, ethanol and isomers of the propanols, such as iso-propanol and n-propanol, and isomers of the butanols are suitable. Ketones for use in the composition include, but are not limited to, acetone and methyl ethyl ketone and mixtures thereof. Glycols and glycol ether solvents are suitable as generally being less odorous, less volatile and more compatible with other cleaning components than are alcohol solvents. Examples of suitable solvents include ethylene glycol, diethyleneglycol, ethylene glycol n-butyl ether, propylene glycol, propylene glycol monomethyl ether, di(propylene glycol) methyl ether and mixtures thereof.

An organic solvent in the water-based cleaning liquid is appropriately selected to help make rinsing with water before the next coating liquid to be sprayed redundant. The total amount of organic solvent may be limited to no more than 50% by weight, for example to no more than 25 percent by weight, and, for example, to no more than 15% by weight, of the composition. The total amount of chelating agent, when present, may be in the range 0.1-15% wt/wt, for example 0.5-10% wt/wt, for example 1-5% wt/wt; although in some compositions of this invention no organic solvent is present.

The cleaning liquid for use in the present invention may contain at least 90% wt/wt water, for example at least 94% wt/wt water, for example at least 96% wt/wt water. The cleaning liquid may contain at least 97% wt/wt water, for example at least 98% wt/wt.

The cleaning liquid for use in the present invention may contain up to 99.5% wt/wt water, for example up to 99% wt/wt water, for example up to 98.5% wt/wt water.

A method in accordance with the invention may employ a cleaning liquid which comprises:
0.001 to 2% wt/wt preservative
0.01 to 1% wt/wt foam control agent
thickener in an amount to give the cleaning liquid a dynamic viscosity in the range from 1 to 50 dPa·s. and
at least 90% wt/wt water.

The pH of the cleaning liquid may be in the range from 3 to 11. A pH control agent as mentioned above may be employed to achieve a pH value in that pH range.

Optionally the cleaning liquid may contain a surfactant of a type and in an amount described herein.

Optionally the cleaning liquid may contain a chelating agent of a type and in an amount described herein.

Optionally the cleaning liquid may contain a water miscible organic solvent of a type and in an amount described herein.

A cleaning liquid for use in this invention may consist essentially of water, a thickener, a preservative and a foam control agent. The thickener, preservative and foam control agent may be of a type and in an amount as described herein.

A cleaning liquid for use in this invention may consist essentially of water, a thickener, a preservative, a foam control agent and a pH control agent. The thickener, preservative, foam control agent and pH control agent are of a type and in an amount as described herein.

It is believed, without this being any limitation of the invention, that the use of the thickened cleaning liquid of the present invention may give rise to a different mode of action to that of unthickened water or organic solvent used heretofore. Unthickened water or organic solvent is believed to mix with the coating liquid in the spray apparatus. In contrast the cleaning liquid of the present invention is believed to push the remnants of the coating liquid forwards towards the outlet in the spray applicator by a process which could be described as ‘ramming’ or ‘liquid pigging’. Of course, some mixing is inevitable but it is believed that this may happen to a lesser degree when using a liquid cleaning in accordance with the present invention, than when using unthickened water or organic solvent, used heretofore.

The cleaning liquid may be free of dyes and pigments. is the cleaning liquid may be a substantially colourless clear liquid. The cleaning liquid may leave no coloured residue from the cleaning liquid itself, in the spray apparatus.

In the present invention, after the cleaning liquid has been passed through the spray apparatus a second step in which unthickened water is passed through to remove remaining cleaning liquid could be carried out, but it is not considered essential. After the cleaning liquid has been passed through, the spray apparatus may again be ready for coating without any intermediate step, for example a rinse step using unthickened water, or a further cleaning step, involving a further pass-through of a cleaning liquid. A new source of coating liquid may be connected and the coating operation can recommence. It is found that any minor residues of the cleaning liquid in the spray apparatus have no detectable impact on the next spray coating operation.

In a method of the invention wherein a coating liquid is a water-based coating liquid which has passed though the liquid spray apparatus, and wherein a cleaning liquid is used to clean the apparatus in a single pass on termination of the passage of the coating liquid, the following conditions may apply
when the cleaning liquid is a cleaning liquid of the invention as defined herein, X ml of effluent cleaning liquid has been expelled from the apparatus when the concentration of the coating liquid in the effluent cleaning liquid has reached 0.1% wt/wt;
when the cleaning liquid is a test cleaning liquid which differs from the aforesaid cleaning liquid only in that the thickener has been replaced in full by water, Y ml of the effluent cleaning liquid has been expelled from the apparatus when the concentration of the coating liquid in the effluent cleaning liquid has reached 0.1% wt/wt;
the volume X is at least 8% less than, for example at least 12% less than, for example at least 20% less than, the volume Y.

A method of the invention may comprise:
a first spray coating stage, which is terminated;
a cleaning stage which comprises a cleaning method of the invention, as defined herein; and
second spray coating stage, which is commenced after the cleaning stage and without an intermediate rinsing stage having been carried out.

A liquid spray apparatus which is cleaned in a method of the invention may be of any type. It may be an airless sprayer in which coating liquid is advanced to the spray applicator and then expelled, by direct force. It may be an air (or other gas) driven sprayer in which compressed gas is used to drive coating liquid to the spray applicator or a variant of that type in which compressed gas is used to control the shape of the emitted spray of coating liquid. Examples of this type of spray apparatus are given in EP 3 485 982 A1. An example of a suitable spray applicator which can be used with this type of spray apparatus are given in WO 2016/024107 A1. These sources may be consulted for further information but important features of such spray apparatus are described next.

A spray apparatus for spraying a coating liquid, the coating liquid having to be cleaned from the coating apparatus in the method of the invention, may comprise:
a reservoir having an outlet for coating liquid
a spray applicator connected to the reservoir to receive coating liquid therefrom
means for urging coating liquid from the reservoir to the spray applicator
an outlet in the spray applicator for the expulsion of coating liquid
a primary gas outlet in the spray applicator for atomising expelled coating liquid
a secondary gas outlet in the spray applicator for impinging upon the expelled and atomised coating liquid and modifying its spray profile.

In a cleaning method such liquid spray apparatus may be operated to expel cleaning liquid in substantially the same manner as coating liquid is expelled during a coating method. For cleaning, the reservoir of coating liquid (which may now be empty) may be removed from the liquid spray apparatus and replaced by a reservoir containing the cleaning liquid. The reservoir for cleaning liquid may be fitted into the liquid spray apparatus using the same fittings provided for the reservoir for coating liquid. The reservoir for cleaning liquid may be the same size as the reservoir for coating liquid or it may be larger, or smaller. The cleaning method suitably comprises steps of supplying cleaning liquid in a first reservoir and collecting the effluent in a second reservoir.

The spray applicator comprises a liquid inlet for receiving liquid from the liquid outlet of the reservoir, a liquid outlet or nozzle, and an actuator, for example a trigger, for controlling the liquid outlet valve, to start or stop the advance of liquid to the nozzle.

The spray assembly may comprise a source of pressurised gas. The source of pressurised gas may suitably be an air compressor or a compressed gas canister, for example a compressed air canister.

The source of pressurised gas may:
(1) urge coating or cleaning liquid from the reservoir to, and out of, the spray applicator through a nozzle
(2) supply pressurised gas to a primary gas outlet of the spray applicator for atomising the liquid being expelled; and
(3) supply pressurised gas to a secondary gas outlet of the spray applicator for impinging upon the expelled atomised liquid and modifying its spray profile.

When the actuator is released by the operator it is urged to its rest position by a biasing means. Flow of liquid, primary gas and secondary gas may thereby be commonly terminated.

A function of the primary gas is to act upon the liquid and form a spray thereof. The nozzle for liquid expulsion may be provided upstream of the primary gas outlet but the liquid outlet and the primary gas outlet may be located closely adjacent to each other such that liquid and primary gas issue together from the spray applicator, and immediately mix. They may form a divergent spray, for example a generally conical, spray.

A function of the secondary gas is to vary the spray pattern of liquid spray. Typically the primary gas acting upon the expelled liquid produces a divergent spray of the liquid but this is generally not suitable for fast accurate coating. The secondary gas may modify the shape to be, for example, an elliptical or fan shape, such as for accurate coating. The secondary gas outlet may therefore be provided downstream of the primary gas outlet.

The liquid spray apparatus may have secondary gas outlets which generally face each other and produce opposed gas flows which impinge transversely onto the atomised divergent spray from opposed sides and urge the spray into a generally elliptical or fan shape.

On commencement of an individual action of liquid spraying, both primary and secondary gas may be expelled by the spray applicator substantially at the same time as coating or cleaning liquid or may be expelled before any liquid is expelled, such as before any liquid is expelled; and both primary and secondary gas are expelled by the spray applicator are terminated substantially at the same time as liquid flow is terminated or after liquid flow is terminated, such as after liquid flow is terminated. The objective of such measures is to ensure liquid cannot be expelled without primary and secondary gas being co-expelled.

The invention also provides a kit of parts for use in carrying out a method of the invention as defined herein, the kit of parts comprising:
a liquid spray apparatus,
a first container containing a coating liquid,
a second container containing the same or a different coating liquid,
a third container containing a cleaning liquid.

A water-based coating liquid—the liquid which is to be cleaned from the spray apparatus—may contain:
binder (resin)
pigment—pigments impart colour and opacity
extender—particles added to improve adhesion, strengthen the film and reduce the quantity of binder needed
solvent—such as water, optionally with low amounts of organic solvents
additives—used to modify the properties of the coating liquid or dry film

The binder (resin) and solvent together are sometimes known as the vehicle. The binder may be dissolved as a solution or carried as a dispersion of microscopically small particles in a liquid.

Aqueous coating liquids typically comprise an aqueous dispersion or emulsion of an organic film-forming binder polymer which brings about both binding of a dried coat of the composition to a surface to which it has been applied and binding any other ingredients of the composition such as pigments, opacifiers, extenders, waxes, rheology control agents, emulsifiers and biocides into the dried coat.

A wide variety of conventional film-forming binder polymers are available for use in aqueous coating compositions, but those most commonly used are alkyd emulsions, polyurethane modified alkyd emulsion, acrylic modified alkyd emulsions, polyurethane dispersions and acrylic dispersions including pure acrylics, polyurethane modified acrylics and copolymer dispersions based on acrylic monomers and styrene, acrylic monomers and vinyl acetate and (meth)acrylic monomers and vinyl versatate and mixtures thereof. Acrylic monomers comprise the monomeric alkyl esters of acrylic acid and methacrylic acid, and also their derivatives based on acrylic monomers and styrene, acrylic monomers and vinyl acetate, and acrylic monomers and vinyl versatate; and mixtures thereof. Acrylic monomers comprise the monomeric alkyl esters of acrylic acid and methacrylic acid, and also their derivatives.

Depending on the type of coating liquid and intended use, additives may include:
dispersants—to separate and stabilise pigment particles
silicones—to improve weather resistance
thixotropic agents—to give coating products a jelly-like consistency that breaks down to a liquid when subject to stress
driers—to accelerate drying time
anti-settling agents—to prevent pigment settling
bactericides—to preserve water based coating liquids in the can
fungicides and algaecides—to protect exterior films against disfigurement from moulds, algae and lichen.

Binders (resins) used in liquids for coatings may be:
acrylic polymers
alkyd polymers
alkyd-acrylic hybrid polymers
polyurethane polymers
polyurethane—acrylic copolymers
styrene—acrylic copolymers
vinyl acetate—acrylic copolymers
vinyl acetate—maleate copolymers
vinyl acetate—ethylene copolymers
vinyl versatate—vinyl acetate copolymers
vinyl versatate—acrylic copolymers

The polymers used in these coating liquids are carried in water (water-borne emulsion coating liquids).

Acrylic latexes include pure acrylics, styrene acrylics, and vinyl acrylics. Pure acrylics are usually composed of at least two alkyl esters of mono-ethylenically unsaturated carboxylic acids (eg. methyl, ethyl, butyl or 2-ethylhexyl esters of acrylic or methacrylic acids) and optionally with low amounts of non-esterified acids (eg. acrylic or methacrylic acid). Styrene acrylics are copolymers containing styrene (or a similar mono-vinyl aromatic monomer) together with a copolymerisable monomer which is usually an alkyl ester of acrylic or methacrylic acid. Vinyl acrylics usually comprise copolymers of a vinyl ester of a monocarboxylic acid such as vinyl acetate or vinyl propionate or a vinyl ester of a monocarboxylic acid containing 9 to 12 carbon atoms such as those sold under the trade name VEOVA by Hexion and at least one (meth)acrylic monomer.

In addition to copolymers composed of (meth)acrylic monomers and vinyl acetate, styrene, or vinyl versatate, more copolymers of (meth)acrylic monomers are possible for use in aqueous coating liquids such as and fluoromonomers including vinylidene fluoride (VDF), hexafluoropropylene (HFP), maleic anhydride, dialkyl maleate, itaconic acid esters, acrylonitrile and acrylamide.

An alkyd resin suitable for use in an emulsion may be formed by adding surfactants, anionic and/or nonionic, to molten alkyd resin and then adding water under shear. An alkyd emulsion contains very little to no organic solvent, inverting from a water-in-oil to an oil-in-water mixture. Typically 5-10% surfactant levels may be used to form an alkyd emulsion.

Another type of alkyd resin is made by polymerizing a high-Tg acrylic shell around an alkyd core; this technology is referred to as core shell alkyd dispersion or alkyd-acrylic polymer technology. During manufacturing, a low-molecular-weight alkyd is copolymerised with a high-Tg, hydrolysis-resistant acrylic monomer, grafting the acrylic to the alkyd. Acid functionality is built into the acrylic shell, which is then salted with an amine to make the acrylic-modified alkyd water dispersible. The acrylic shell surrounds the alkyd, protecting it from hydrolysis, making the core shell hybrid dispersion more shelf stable than a typical water-reducible alkyd. This core shell hybrid dispersion has faster dry times than an alkyd emulsion due to the high-Tg acrylic shell.

A further type of aqueous alkyd resins is the class of PU-modified alkyd emulsions. The technology of PU-modified alkyd emulsions is based the incorporation of carboxyl groups into the resin followed by neutralization of the resin with amines or hydroxides and emulsification in water. No external emulsifiers and no co-solvents are needed to obtain stable resin emulsions.

Pigments give colour and opacity to coatings. Organic pigment(s) may comprise azo-, phthalocyanine, diketo-pyrrolo-pyrrole, quinacridone and/or anthraquinone derivatives.

The most common inorganic pigment is white titanium dioxide (titanium(IV) oxide) which provides over 70% of total pigments used. It has a high refractive index and gives opacity to the film. Other inorganic pigments include iron oxides (black, yellow and red), zinc oxide and carbon black.

Powdered metals such as zinc and some metal compounds, for example zinc phosphate, have corrosion inhibiting properties. Another widely used inorganic pigment is finely divided calcium carbonate. This has a low refractive index and can be used, together with titanium dioxide, to produce ‘matt’ films. Because of its low refractive index calcium carbonate may also be considered as an extender.

A coating liquid may be any water-based coating liquid, having any of the binders identified herein, for example acrylic binder, alkyd binder or alkyd-acrylic hybrid binder.

A coating liquid in relation to this invention may be a pigmented, water-based paint.

### EXAMPLES

These examples relate to cleaning liquid used to clean a coating liquid, namely a paint, from a liquid spray apparatus of the type described above (and in EP 3 485 982 A1 and WO 2016/024107 A1). It will be understood that these examples are provided to provide exemplification of the present invention. The invention is not limited in its use to this spray apparatus or to the cleaning of paint.

The low shear viscosity of the paint was measured with Physica Rheolab MC1 viscosimeter using a E100 spindle at a rotation speed at of 181 rpm at 23° C.

The solids content of aqueous solutions was measured with the moisture analyser Sartorius MA45 IR.

The spectrophotometer employed was a HACH Lange DR5000 UV-VIS spectrophotometer. The cuvette length is 1 mm and the absorbance was measured at 600 nm.

Unless otherwise indicated, all parts and all percentages in the following examples, as well as throughout the specification, are parts by weight or percentages by weight respectively.

The following commercial products were used:
ACTICIDE BW 20 is a biocidal product containing 1,2 benzothiazolone, to protect the aqueous formulation from contamination, commercially available from Thor.
ACTICIDE ICB 3 is a biocidal product to protect the aqueous formulation from contamination, comprising 1,2 benzothiazolone and zinc pyrithione, commercially available from Thor.
ACTICIDE MBS 5050 is a concentrated biocide specifically developed for the wet-state protection of water based products, commercially available from Thor.
DREW 210-694 is a foam control agent, commercially available from Ashland.
TYLOSE MH6000 YP4 is a methyl hydroxyethyl cellulose-based non-associative thickener, commercially available from SE Tylose GmbH & Co. KG.

### Example 1

A thickened aqueous Cleaning Liquid A shown in Table 1 below was prepared by mixing the following components at ambient temperature.

TABLE 1

| Component | Amount % wt/wt |
|---|---|
| Water | 97.78 |
| ACTICIDE BW 20 | 0.15 |
| ACTICIDE ICB 3 | 0.27 |
| DREW 210-694 | 0.1 |
| TYLOSE MH6000 YP4 | 1.5 |
| Ammonia 25% solution | 0.2 |
| | 100.00 |

Cleaning Liquid A was tested in comparison with water and with two other compositions, both solvent based: DOWANOL DPM (dipropylene glycol monomethyl ether) and NIKUTEX 1837 AQUAPURGE, a commercial spray apparatus cleaning liquid (available from Kluthe), comprising butyl glycol (25-50% wt/wt and less than 2.5% wt/wt of ethoxylated quaternary ammonium salts and water. The viscosity of Cleaning Liquid A is 9.0 dPa·s, and the viscosities of DOWANOL DPM, NIKUTEX 1837 AQUAPURGE, and water are less than 0.1 dPa·s

Tests were carried out to determine the amount of cleaning liquid needed to clean the paint transmission line and spray applicator of the spray apparatus. The spray apparatus comprises a control unit containing an accommodation chamber for receiving a receptacle containing a reservoir of paint, and subsequently for receiving a cleaning liquid. The control unit is connected to a paint transmission line, which leads to a spray applicator. Pressurised air at a pressure of 2 bar over atmospheric pressure was used to advance the paint, and pressurised air also was also supplied to two separate air lines running alongside the paint transmission line and through the applicator, each at a pressure of 1 bar over atmospheric pressure, to provide the desired pattern of spray output. One air line exits the applicator closely adjacent to the paint nozzle of the applicator and atomizes the paint, forming a divergent conical spray pattern. The second air line exits the applicator downstream thereof in opposed air streams impinging transversely onto the divergent conical spray pattern, to modify its shape and produce a flatter spray profile.

For coating operation the reservoir of a receptacle was filled with an aqueous spray quality paint based on alkyd-acrylic hybrid technology, and the receptacle was loaded into an accommodating chamber in the main body of the spray apparatus. Pressurised air was supplied to a displacement member, the displacement member being provided in the receptacle, and serving to impel liquid from the reservoir towards the spray applicator. On activating a trigger of the spray applicator the paint is propelled from the nozzle of the spray applicator. The paint spray pattern was modified by the two pressurised air flows, through the two separate air lines.

After paint spray application was completed, the pressure on the air side of the displacement member was reduced to atmospheric pressure and the receptacle was unloaded from the accommodating chamber of the main unit. The reservoirs of four clean receptacles were provided, filled with the respective cleaning liquids identified in Table 2, and the receptacles were loaded in turn into the accommodation chamber, each time after the same paint had been sprayed under the same conditions.

The compressor or other source of pressurised air acted on the receptacle so that the respective cleaning liquid under test was driven out of the receptacle towards the spray applicator. The spray apparatus was operated to pass cleaning liquid through the transmission line and spray applicator, from which it was sprayed into an empty receptacle. At first about 40 grams of pure paint was discharged from the spray applicator before the spray applicator started to sputter (M1). This paint is the paint left in the transmission line and spray actuator after spraying. This paint was collected separately. Subsequently as effluent was discharged it became progressively less contaminated and finally became optically clear/clean. The amount of cleaning liquid used until the effluent was optically clear/clean was collected and weighed (value M2, below). The less cleaning liquid needed, the more efficient was the cleaning. The solids content of the effluent after the amount M2 had been run through the transmission line and the spray gun was measured gravimetrically by using the IR dryer, Sartorius MA45 IR, and corrected for the solids content of the cleaning liquids as delivered to the spray apparatus. The solids content of the effluent corrected for the solids content of the initial cleaning liquid is value M3, given below. The lower the solids content of the effluent, the better the performance of the cleaning liquid.

The results are given in Table 2 below.

TABLE 2

| | M2 (g) | M3 (% wt/wt) |
|---|---|---|
| Cleaning Composition A | 280 | 0.03 |
| DOWANOL DPM | 597 | 0.13 |
| NIKUTEX 1837 AQUAPURGE | 621 | 2.79 |
| Water | 628 | 0.40 |

The M3 value of Cleaning Composition A (corrected for the solids content of Cleaning Composition A as used) was only 0.03% wt/wt. This is an extremely low value and was achieved using only 280 g of the cleaning liquid. This is less than half the amount of the other cleaning liquids needed to secure their much-inferior solids values M3.

At the end of the cleaning operation most of the Cleaning Liquid A which passed through the paint transmission line and spray applicator will have been removed by spraying from the applicator. Only a very small amount of residual cleaning liquid would be left inside and we have found that it is compatible with the next loading of aqueous based paint, and has no detectable effect on the quality of later painting or any other aspect of a subsequent spraying operation. Thus, after cleaning of the spray apparatus using Cleaning Composition A the spray apparatus can be re-connected to a paint source, and painting can recommence, without any rinsing step.

### Example 2

Seven thickened aqueous Cleaning Liquids B-H of increasing viscosities were prepared analogously to the Cleaning Liquid A. The viscosities of the Cleaning Liquids were varied by varying the amount of TYLOSE MH6000 YP4.

TABLE 3

| | Cleaning | Cleaning | Cleaning | Cleaning | Cleaning | Cleaning | Cleaning |
|---|---|---|---|---|---|---|---|
| Amounts % wt/wt | Liquid B | Liquid C | Liquid D | Liquid E | Liquid F | Liquid G | Liquid H |
| Water | 99.5 | 98.8 | 98.5 | 98.2 | 97.9 | 97.6 | 97.3 |
| ACTICIDE MBS 5050 | 0.2 | 0.2 | 0.2 | 0.2 | 0.2 | 0.2 | 0.2 |
| DREW 210-694 | 0.1 | 0.1 | 0.1 | 0.1 | 0.1 | 0.1 | 0.1 |
| TYLOSE MH6000YP4 | 0.0 | 0.8 | 1.0 | 1.3 | 1.6 | 1.9 | 2.2 |
| Aqueous NaOH (% wt/wt) | 0.2 | 0.2 | 0.2 | 0.2 | 0.2 | 0.2 | 0.2 |
| Viscosity (dPa · S) | 0.0 | 0.9 | 2.0 | 5.1 | 9.9 | 20.0 | 30.0 |

For these tests, the solids content of the effluents as a function of volume of the collected cleaning liquids was measured by VIS-spectroscopy. The spray apparatus and the cleaning process are as described in Example 1. After removal of an empty reservoir of paint and the first spray-out (M1) of pure paint from the transmission line, the cleaning process was stopped each time after portions of about 50 ml of cleaning liquid was passed through the transmission line and spray applicator and collected in a receptacle. A sample of about 10 ml of the effluent was taken and the next 50 ml of cleaning liquid was passed through the transmission line and spray applicator until the complete volume of 600-700 ml of cleaning liquid had been passed through the transmission line and spray applicator.

The concentration of residual paint in the 10 ml samples of the effluent was determined by a spectrophotometric method.

For each of the Cleaning Liquids B-H, individual calibration curves were constructed. To each of the Cleaning Liquids B-H, 0.01, 0.02, 0.05, 0.1, and 0.2% (wt/wt) of the aqueous spray quality paint was added and the absorbance of the mixtures was measured at 600 nm. The absorbance versus paint concentration was plotted and six linear calibration curves with the y-intercept going through the origin were created.

The absorbance of the 10 ml samples of the effluent was measured at 600 nm and from this the concentrations of residual paint in the effluent samples could be determined. Effluent samples having a paint concentration higher than 0.2% wt/wt were diluted before spectrophotometric measurement with the corresponding fresh cleaning liquid to a concentration that falls within the calibration range.

Efficiency curves of the distinct cleaning liquids displaying the concentration of the residual paint in the effluent as a function of the amount of cleaning liquid that was run through the transmission line and the spray applicator have been derived. From these efficiency curves, the amount of cleaning liquid required to reduce the residual paint in the effluent to 0.1% was calculated. The 0.1% figure was the benchmark chosen as ‘optically clean’. Another value could have been picked with substantially the same outcome.

As is shown in Table 4, the cleaning efficiency of the cleaning liquids was found to increase as a function of viscosity. Aqueous cleaning liquids of a viscosity of 0.9 dPa·s and higher are found to have beneficial cleaning behaviour. Low amounts of thickened cleaning liquids are shown provide optically clean transmission lines and spray applicators, ready to receive the next loading of aqueous spray quality paint. Aqueous cleaning liquids of a viscosity above 2 dPa·s show a highly efficient cleaning behaviour.

TABLE 4

| | | mass of Cleaning |
|---|---|---|
| | | Liquid (g) required to |
| | viscosity | reduce residual paint |
| Cleaning Liquid | (dPa.S) | to 0.1% (wt/wt) |
| Cleaning Liquid B | 0.0 | 610 |
| Cleaning Liquid C | 0.9 | 540 |
| Cleaning Liquid D | 2.0 | 517 |
| Cleaning Liquid E | 5.1 | 471 |
| Cleaning Liquid F | 9.9 | 368 |
| Cleaning Liquid G | 20.0 | 362 |
| Cleaning Liquid H | 30.0 | 311 |

Although exemplary embodiments of the present invention have been shown and described, it will be appreciated by those skilled in the art that changes may be made without departing from the scope of the invention as defined in the claims.

It will be appreciated that the coating liquid may be any kind of coating liquid. For example, the coating liquid may be a paint, a varnish, a stain etc. The coating liquid may comprise a decorative coating liquid, such as a decorative coating for masonry surfaces or for wood surfaces (such as use of a water based coating, or others, which may be applied directly onto such surfaces or overcoated onto existing coatings on such surfaces, for example). The coating liquid may include a protective coating, such as a protective coating which may be used on marine structures (such as marine platforms, for example) or on marine vessels (such as boats, for example), or on oil and gas processing structures.

Capitalised names given herein for products are believed to be trade names and may be Registered Trade Marks.

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Singular encompasses plural and vice versa. For example, although reference is made herein to “a thickener”, “a preservative”, “a surfactant” and the like, one or more of each of these and any other components can be used.

As used herein, the term “polymer” refers to oligomers and both homopolymers and copolymers, and the prefix “poly” refers to two or more.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the coating liquids detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

1. A method of cleaning a liquid spray apparatus for a coating liquid after use, the method comprising passing a water-based cleaning liquid through the liquid spray apparatus; wherein the cleaning liquid contains a thickener.

2. A method as claimed in claim 1, wherein the dynamic viscosity of the cleaning liquid is up to 50 dPa·s.

3. A method as claimed in claim 1, wherein the dynamic viscosity of the cleaning liquid is at least 1 dPa·s.

4. A method as claimed in claim 1, wherein the thickener is a non-associative thickener.

5. A method as claimed in claim 4, wherein the thickener is selected from a cellulosic thickener, an acrylic thickener, a starch based thickener, a gum, a clay, a modified ethylene vinyl acetate compound and a zirconium, acetate lactate oxo ammonium complex.

6. A method as claimed in claim 5, wherein the thickener comprises a cellulose ether.

7. A method as claimed in claim 6, wherein the thickener comprises an alkyl hydroxyalkyl cellulose.

8. A method as claimed in claim 1, wherein the thickener is present in an amount of at least 0.1% wt/wt.

9. A method as claimed in claim 1, wherein the cleaning liquid comprises:
0.001 to 2% wt/wt preservative,
0.01 to 1% wt/wt foam control agent,
thickener in an amount to give the cleaning liquid a dynamic viscosity in the range from 1 to 50 dPa·s, and
at least 90% wt/wt water,
wherein the pH of the cleaning liquid is in the range from 3 to 11.

10. A method as claimed in claim 1, wherein the cleaning liquid contains from 90 to 99.5% wt/wt water.

11. A method as claimed in claim 1, wherein the coating liquid is a water-based coating liquid which has passed though the apparatus, and wherein a cleaning liquid is used to clean the apparatus in a single pass on termination of the passage of the coating liquid;
wherein when the cleaning liquid is a cleaning liquid as defined in claim 1, X ml of effluent cleaning liquid has been expelled from the apparatus when the concentration of the coating liquid in the effluent cleaning liquid has reached 0.1% wt/wt;
wherein when the cleaning liquid is a test cleaning liquid which differs from said cleaning liquid only in that the thickener has been replaced in full by water, Y ml of effluent cleaning liquid has been expelled from the apparatus when the concentration of the coating liquid in the effluent cleaning liquid has reached 0.1% wt/wt;
wherein the volume X is at least 8% less than the volume Y.

12. A method of spray coating a surface, the method comprising:
a first spray coating stage, which is terminated;
a cleaning stage which comprises a cleaning method as claimed in claim 1; and
a second spray coating stage, which is commenced after the cleaning stage and without a rinsing stage or any other intermediate stage having been carried out.

13. A method as claimed in claim 12, wherein the coating liquid for the first and second spray coating stages is supplied in containers and the cleaning liquid is supplied in a compatible container which can be fitted into the spray apparatus in the place of a container for the coating liquid.

14. A method as claimed in claim 12, wherein the liquid spray apparatus cleaned in the method comprises:
a reservoir having a liquid outlet
a spray applicator connected to the reservoir to receive liquid therefrom
means for urging liquid from the reservoir to the spray applicator
a nozzle in the spray applicator for the expulsion of liquid
a primary gas outlet in the spray applicator for atomising expelled liquid
a secondary gas outlet in the spray applicator for impinging upon the expelled and atomised liquid and modifying its spray profile.

15. A kit of parts for use in carrying out a method as claimed in claim 12, the kit of parts comprising:
a liquid spray apparatus,
a first container containing a coating liquid,
a second container containing the same or a different coating liquid,
a third container containing a cleaning liquid.
